(19) United States
(12) Patent Application Publication
(10) Pub. No.: US 2025/0139425 A1
(43) Pub. Date: May 1, 2025

(54) OPTICAL CONVOLUTIONAL COMPUTING DEVICE AND METHOD OF OPERATING THE SAME

(71) Applicant: ELECTRONICS AND TELECOMMUNICATIONS RESEARCH INSTITUTE, Daejeon (KR)

(72) Inventors: Jin Hwa GENE, Daejeon (KR); Suntak Park, Daejeon (KR); Jong Moo Sohn, Daejeon (KR)

(21) Appl. No.: 18/926,251

(22) Filed: Oct. 24, 2024

(30) Foreign Application Priority Data
Oct. 26, 2023 (KR) 10-2023-0144817
Aug. 7, 2024 (KR) 10-2024-0105742

(51) Int. Cl. G06N 3/067; G06N 3/0464

(52) U.S. Cl. CPC G06N 3/067; G06N 3/0464

(57) ABSTRACT

An optical convolutional computing device includes an image-based spatial light modulator (SLM) configured to modulate a multi-wavelength light based on aspatial domain image data, and output modulated light; an optical demultiplexer configured to output first to N-th sub-lights having first to N-th wavelengths, respectively, based on the modulated light; an optical convolution processor configured to receive the first to N-th sub-lights and output first to N-th inversely transformed lights; and an optical multiplexer configured to align paths of the first to N-th inversely transformed lights, wherein N is a natural number greater than or equal to 2.

### CROSS-REFERENCE TO RELATED APPLICATIONS

This application claims priority under 35 U.S.C. § 119 to Korean Patent Application Nos. 10-2023-0144817 filed on Oct. 26, 2023, and 10-2024-0105742 filed on Aug. 7, 2024, in the Korean Intellectual Property Office, the disclosures of which are incorporated by reference herein in their entireties.

### BACKGROUND

Embodiments of the present disclosure described herein relate to an optical convolutional computing device, and more particularly, relate to an optical convolutional computing device and a method of operating the same.

Convolutional Neural Networks (CNNs) are artificial neural network structures used for image classification and inference. The Convolutional Neural Networks are widely used in fields that require image processing devices, such as autonomous driving and Internet of Things along with the development of wireless communication. The computations required by convolutional neural networks are becoming more complex and the amount of computation is increasing, but electronic computers have low energy efficiency and low computing speed.

Optical convolutional computing devices may perform convolutional computing of convolutional neural networks optically. A typical optical convolutional computing device utilizes an optical 4f system that uses a single-wavelength coherent light source. An optical convolutional computing device uses two SLMs (spatial light modulators), and each of the SLMs may receive multiple spatial domain image data and one Fourier kernel data.

Furthermore, when the optical convolutional computing device that uses the single-wavelength coherent light source performs computations in parallel by applying multiple kernels, the number of image sensors required to recognize each computational result of the parallel computations increases, or the accuracy of the computational result decreases due to interference when synthesizing the computational results.

### SUMMARY

Embodiments of the present disclosure are directed to an optical convolutional computing device and a method of operating the same.

In an embodiment, an optical convolutional computing device includes an image-based spatial light modulator (SLM) configured to modulate a multi-wavelength light based on aspatial domain image data, and output modulated light; an optical demultiplexer configured to output first to N-th sub-lights having first to N-th wavelengths, respectively, based on the modulated light; an optical convolution processor configured to receive the first to N-th sub-lights and output first to N-th inversely transformed lights; and an optical multiplexer configured to align paths of the first to N-th inversely transformed lights, wherein N is a natural number greater than or equal to 2.

The optical convolution computing device of claim may further include a multi wavelength light generator configured to output multi-wavelength light having first to N-th wavelengths and/or an image sensor configured to sense the synthesized light

According to an embodiment of the present disclosure, an optical convolutional computing device includes a multi-wavelength light generator that outputs multi-wavelength light having first to N-th wavelengths, an image-based spatial light modulator (SLM) that receives spatial domain image data and modulates the multi-wavelength light based on the spatial domain image data to output modulated light, an optical demultiplexer that outputs first to N-th sub-lights having the first to N-th wavelengths, respectively, based on the modulated light, using at least one optical device, first to N-th transform devices that performs Fourier transform on the first to N-th sub-lights, respectively, using at least one optical device, and outputs first to N-th transformed lights, respectively, first to N-th kernel-based SLMs that respectively receives first to N-th kernel data, and respectively modulates the first to N-th transformed lights based on the first to N-th kernel data to output first to N-th kernel product lights, respectively, first to N-th inverse transform devices that respectively performs inverse Fourier transform on the first to N-th kernel product lights using at least one optical device, respectively, and outputs first to N-th inversely transformed lights, respectively, an optical multiplexer that matches paths of the first to N-th inversely transformed lights using at least one optical device, and outputs synthesized light, and an image sensor that senses the synthesized light, and the “N” is a natural number greater than or equal to “2”.

According to an embodiment, each of the first to N-th transform devices may include at least one lens.

According to an embodiment, the image-based SLM may be a transmissive SLM, the multi-wavelength light may be input to the image-based SLM in a first direction, and the image-based SLM may output the modulated light to the optical demultiplexer in the first direction, the optical demultiplexer may include first to N-th optical devices disposed in parallel in the first direction, and the first to N-th optical devices may output the first to N-th sub-lights in a second direction perpendicular to the first direction, respectively.

According to an embodiment, the first optical device among the first to N-th optical devices may include at least one dichroic mirror, and each of the remaining optical devices among the first to N-th optical devices may include at least one beam splitter or at least one polarizing beam splitter.

According to an embodiment, the N-th optical device among the first to N-th optical devices may receive the modulated light, may output light corresponding to the N-th wavelength among the first to N-th wavelengths from the modulated light as the N-th sub-light in the second direction, and may output the remaining light, excluding the light corresponding to the N-th wavelength from the modulated light, in the first direction to the (N−1)-th optical device among the first to N-th optical devices.

According to an embodiment, each of the first to N-th kernel-based SLMs may be the transmissive SLM, and the first kernel-based SLM among the first to N-th kernel-based SLMs may receive the first transformed light among the first to N-th transformed lights in the second direction, and may modulate the first transformed light depending on the first kernel data among the first to N-th kernel data and may output the first kernel product light to the first inverse transform device among the first to N-th inverse transform devices in the second direction.

According to an embodiment, the optical multiplexer may include first to N-th optical devices that respectively receives the first to N-th inversely transformed lights in the second direction and respectively changes the paths of the first to N-th inversely transformed lights in a third direction.

According to an embodiment, the third direction may be the same as the first direction.

According to an embodiment, the image-based SLM may be a reflective SLM, the optical convolutional computing device may further include a first incident device that changes an optical path of the multi-wavelength light received from the multi-wavelength light generator in a first direction and outputs the changed multi-wavelength light to the image-based SLM in a second direction perpendicular to the first direction, and the image-based SLM may output the modulated light to the optical demultiplexer in a direction opposite to the second direction.

According to an embodiment, each of the first to N-th kernel-based SLMs may be the reflective SLM, and the optical convolutional computing device may further include first to N-th incident devices disposed parallel to the optical demultiplexer in the first direction, respectively, and the first to N-th incident devices may respectively receive the first to N-th kernel product lights from the first to N-th kernel-based SLMs in a direction opposite to the first direction, and may respectively change optical paths of the first to N-th kernel product lights in the second direction to output the changed first to N-th kernel product lights to the optical multiplexer, respectively.

According to an embodiment, the multi-wavelength light generator may include a first diffraction grating that respectively receives first to N-th input lights in different first to N-th directions, and matches optical paths of the first to N-th input lights in an (N+1)-th direction so as to be output as the multi-wavelength light.

According to an embodiment, the optical demultiplexer may include a second diffraction grating that receives the modulated light and outputs the first to N-th sub-lights respectively having the first to N-th wavelengths in different (N+2)-th to (2N+1)-th directions, respectively.

According to an embodiment, the first transform device among the first to N-th transform devices may receive the first sub-light in the (N+2) direction, and the optical convolutional computing device may further include first to (N−1)-th prisms that respectively receives the first to N-th sub-lights, changes optical paths of the second to N-th sub-lights among the first to N-th sub-lights in the (N+2)-th direction, and outputs the second to N-th sub-lights to the second to N-th inverse transform devices among the first to N-th inverse transform devices, respectively.

According to an embodiment, the optical convolutional computing device may further include a third diffraction grating, and the third diffraction grating may receive the first to N-th inversely transformed lights in first to N-th directions, respectively, and may match the paths of the first to N-th inversely transformed lights in an (N+1)-th direction so as to be output as one synthesized light.

According to an embodiment, the multi-wavelength light generator may output the multi-wavelength light by matching optical paths of first to N-th input lights, based on the first to N-th input lights having the first to N-th wavelengths, respectively.

According to an embodiment, the multi-wavelength light generator may use at least one of a beam splitter, a polarizing beam splitter, and a dichroic mirror to match the optical paths of the first to N-th input lights.

According to an embodiment, the multi-wavelength light generator may receive first to N-th input lights, respectively, and may further include first to N-th weight-based SLMs, and the first to N-th weight-based SLMs may modulate angle frequencies of the first to N-th input lights, respectively, based on first to N-th weight values included in weight data of a convolution neural network (CNN).

According to an embodiment of the present disclosure, an optical convolutional computing device includes a multi-wavelength light generator that outputs multi-wavelength light having first to N-th wavelengths, a digital demultiplexer that receives spatial domain image data, modulates the multi-wavelength light based on the spatial domain image data, and respectively outputs first to N-th sub-lights in different first to N-th directions for each of the first to N-th wavelengths, first to N-th transform devices that performs Fourier transform on the first to N-th sub-lights, respectively, using at least one optical device, and outputs first to N-th transformed lights, respectively, first to N-th digital devices that respectively receives first to N-th kernel data, and respectively modulates the first to N-th transformed lights based on the first to N-th kernel data to output first to N-th kernel product lights, respectively, first to N-th inverse transform devices that respectively performs inverse Fourier transform on the first to N-th kernel product lights using at least one optical device, respectively, and outputs first to N-th inversely transformed lights, respectively, an optical multiplexer that mattes paths of the first to N-th inversely transformed lights using at least one optical device and outputs synthesized light, and an image sensor that senses the synthesized light, and the “N” is a natural number greater than or equal to “2”.

According to an embodiment, at least one of the digital demultiplexer and the first to N-th digital devices may include a DMD (digital micro-mirror device).

According to an embodiment of the present disclosure, a method of operating an optical convolutional computing device including a multi-wavelength light generator, an image-based SLM, an optical demultiplexer, first to N-th transform devices, first to N-th kernel-based SLMs, first to N-th inverse transform devices, an optical multiplexer, and an image sensor, includes generating, by the multi-wavelength light generator, multi-wavelength light having first to N-th wavelengths, modulating, by the image-based SLM, the multi-wavelength light based on spatial domain image data and outputting the modulated light, outputting, by the optical demultiplexer, first to N-th sub-lights having first to N-th wavelengths, respectively, based on the modulated light, using at least one optical device, performing, by the first to N-th transform devices, Fourier transform on the first to N-th sub-lights, respectively, using at least one optical device and outputting first to N-th transformed lights, respectively, modulating, by the first to N-th kernel-based SLMs, the first to N-th transformed lights, respectively, based on first to N-th kernel data respectively and outputting first to N-th kernel product lights, respectively, performing, by the first to N-th inverse transform devices, inverse Fourier transform, respectively, on the first to N-th kernel product lights, using at least one optical device respectively and outputting first to N-th inversely transformed lights, respectively, matching, by the optical multiplexer, paths of the first to N-th inversely transformed lights using at least one optical device and outputting synthesized light, and sensing, by the image sensor, the synthesized light, and the “N” is a natural number greater than or equal to “2”.

According to an embodiment, an optical convolutional computing device includes an image-based spatial light modulator (SLM) configured to receive multi-wavelength light having a plurality of wavelengths, modulate the multi-wavelength light based on spatial domain image data, and output modulated light. An optical demultiplexer is configured to output a plurality of sub-lights based on the modulated light, each sub-light having a given wavelength. An optical convolution processor is configured to receive the sub-lights and output a plurality of inversely transformed lights. An optical multiplexer is configured to align paths of the inversely transformed lights and output synthesized light.

According to an embodiment, an optical convolution computing device includes a light generator configured to output the multi-wavelength light having the plurality of wavelengths.

According to an embodiment, an optical convolution computing device includes an image sensor configured to sense the synthesized light.

According to an embodiment, an optical convolution computing device includes a light generator configured to output the multi-wavelength light having the plurality of wavelengths; and an image sensor configured to sense the synthesized light. The optical convolution processor includes a plurality of transform devices configured to perform Fourier transform on the sub-lights and output a plurality of transformed lights; a plurality of kernel-based SLMs configured to receive kernel data and modulate the transformed lights based on the kernel data to output a plurality of product lights; and a plurality of inverse transform devices configured to perform inverse Fourier transform on the kernel product lights and output a plurality of inversely transformed lights.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a general optical convolutional computing device.

FIG. 2 is a block diagram illustrating a general optical convolutional computing device that performs parallel computing.

FIG. 3 is a diagram illustrating sensing image data sensed by an image sensor of FIG. 2.

FIG. 4 is a block diagram illustrating an optical convolutional computing device according to an embodiment of the present disclosure.

FIG. 5 illustrates an optical convolutional computing device to which a transmissive SLM (spatial light modulator) is applied, according to an embodiment of the present disclosure.

FIG. 6 illustrates an optical convolutional computing device to which a reflective SLM is applied according to an embodiment of the present disclosure.

FIG. 7 illustrates an optical convolutional computing device to which a diffraction grating is applied according to an embodiment of the present disclosure.

FIG. 8 illustrates an optical convolutional computing device to which a digital device is applied according to an embodiment of the present disclosure.

FIG. 9 is a diagram illustrating sensing image data sensed by an image sensor of FIG. 4.

FIG. 10 is a flowchart illustrating an operation of an optical convolutional computing device according to an embodiment of the present disclosure.

### DETAILED DESCRIPTION

Hereinafter, embodiments of the present disclosure will be described in detail and clearly to such an extent that an ordinary one in the art easily implements the present disclosure.

The terms “unit,” “module,” etc. to be used below and function blocks illustrated in drawings may be implemented in the form of a software component, a hardware component, or a combination thereof. Below, to describe the technical idea of the inventive concept clearly, a description associated with identical components will be omitted. As used herein, including in the claims, “or” as used in a list of items prefaced by a phrase such as “at least one of” or “one or more of” or “one or both of” indicates an inclusive list such that, for example, a list of at least one of A, B, or C indicates A or B or C or AB or AC or BC or ABC (i.e., A and B and C).

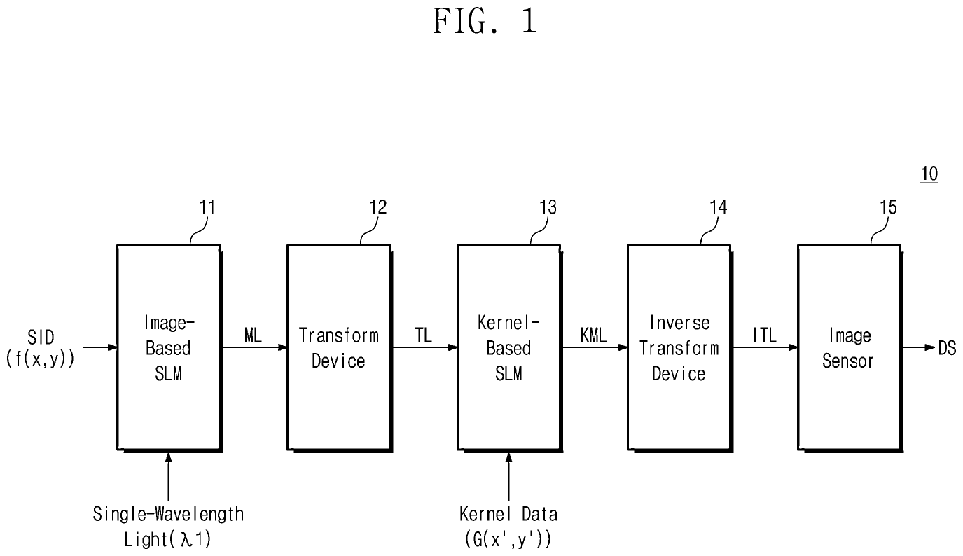

FIG. 1 is a block diagram illustrating a general optical convolutional computing device 10. Referring to FIG. 1, the optical convolutional computing device 10 includes an image-based SLM (spatial light modulator) 11, a transform device 12, a kernel-based SLM 13, an inverse transform device 14, and an image sensor 15.

The general optical convolutional computing device 10 may perform a convolutional computing on spatial domain image data (SID) and kernel data using at least one optical device. The optical convolutional computing device 10 may be included and used in a convolutional neural network (CNN). In the optical convolutional computing device used in the convolutional neural network, the spatial domain image data (SID) may refer to image data targeted for processing and analysis by the convolutional neural network. The kernel data may correspond to at least one of kernels included in the convolutional neural network.

The convolutional computing follows a convolutional theorem as illustrated in Equation 1.

$$f ( x , y ) * g ( x , y ) = {𝒥}^{- 1} \{ F ( {x}^{′} , {y}^{′} ) \cdot G ( {x}^{′} , {y}^{′} ) \} \qquad [ Equation 1 ]$$

In this case, f(x,y) may refer to a spatial domain image function corresponding to spatial domain image data, may refer to a spatial domain kernel function corresponding to spatial domain kernel data, F(x′, y′) may refer to a Fourier domain image function, and G(x′, y′) may refer to a Fourier domain kernel function.

The Fourier domain image function is a function that applies the Fourier transform to the spatial domain image function, and the Fourier domain kernel function is a function that applies the Fourier transform to the spatial domain kernel function. The Fourier domain kernel function may correspond to kernel data used in the convolutional neural network.

Referring again to Equation 1, convolving the spatial domain image function with the spatial domain kernel function may be equivalent to performing element-wise multiplication of the Fourier domain image function and the Fourier domain kernel function, followed by an inverse Fourier transform that is performed on the result of the element-wise multiplication.

In general, a SLM is a transform device that modulates incident light in a spatial pattern corresponding to an electrical input or an optical input. The modulation may affect the phase, intensity, polarization, or direction of the incident light, and can be achieved using various materials exhibiting various electro-optical or magneto-optical effects, or by materials that modulate light through expression transformation.

The image-based SLM 11 may receive spatial domain image data f(x, y). In addition, single-wavelength light having a first wavelength λ1 may be incident on the image-based SLM 11. The single-wavelength light may be coherent light.

The image-based SLM 11 may modulate the single-wavelength light based on the spatial domain image data f(x, y) and output modulated light ML. For example, the image-based SLM 11 may modulate the optical amplitude or the optical frequency of the single-wavelength light to generate the modulated light ML having a waveform corresponding to the spatial domain image data f(x, y). The modulated light ML output from the image-based SLM 11 may refer to light transmitted through the image-based SLM 11 or reflected from the image-based SLM 11.

The transform device 12 may receive the modulated light ML. In detail, the modulated light ML may be incident on the transform device 12. The transform device 12 may include at least one optical device. For example, the transform device 12 may include a single lens or multi-lens system. The modulated light ML may pass through at least one optical device. The transform device 12 may perform a Fourier transform on the modulated light ML using at least one optical device and output transformed light TL.

The kernel-based SLM 13 may receive Fourier domain kernel data G(x′, y′) and the transformed light TL. In detail, the transformed light TL may be incident on the kernel-based SLM 13. The kernel-based SLM 13 may modulate the transformed light TL based on the Fourier domain kernel data G(x′, y′) and output kernel product light KML. The kernel product light KML may refer to the light transmitted or reflected from the kernel-based SLM 13.

Specifically, the kernel-based SLM 13 may perform the element-wise multiplication on the transformed light TL and the Fourier domain kernel data G(x′, y′). Since the transformed light TL is in the Fourier domain, the element-wise multiplication by the kernel-based SLM 13 follows the same principle as the element-wise multiplication between Fourier domain functions.

The inverse transform device 14 may receive the kernel product light KML. In detail, the kernel product light KML may be incident on the inverse transform device 14. The inverse transform device 14 may include at least one optical device. For example, the inverse transform device 14 may include a single lens or multi-lens system. The inverse transform device 14 may perform an inverse Fourier transform on the kernel product light KML using at least one optical device and output an inversely transformed light ITL. In this case, the inversely transformed light ITL may correspond to the result of the convolution between the spatial domain functions as described in Equation 1.

The image sensor 15 may sense the inversely transformed light ITL and generate a digital signal DS in the form of image data. For example, the image sensor 15 may be a camera.

Since the Fourier domain kernel data G(x′, y′) input to the kernel-based SLM 13 corresponds to only one kernel, the time required for the optical convolutional computing device 10 to perform convolutional computations may increase with the number of kernels.

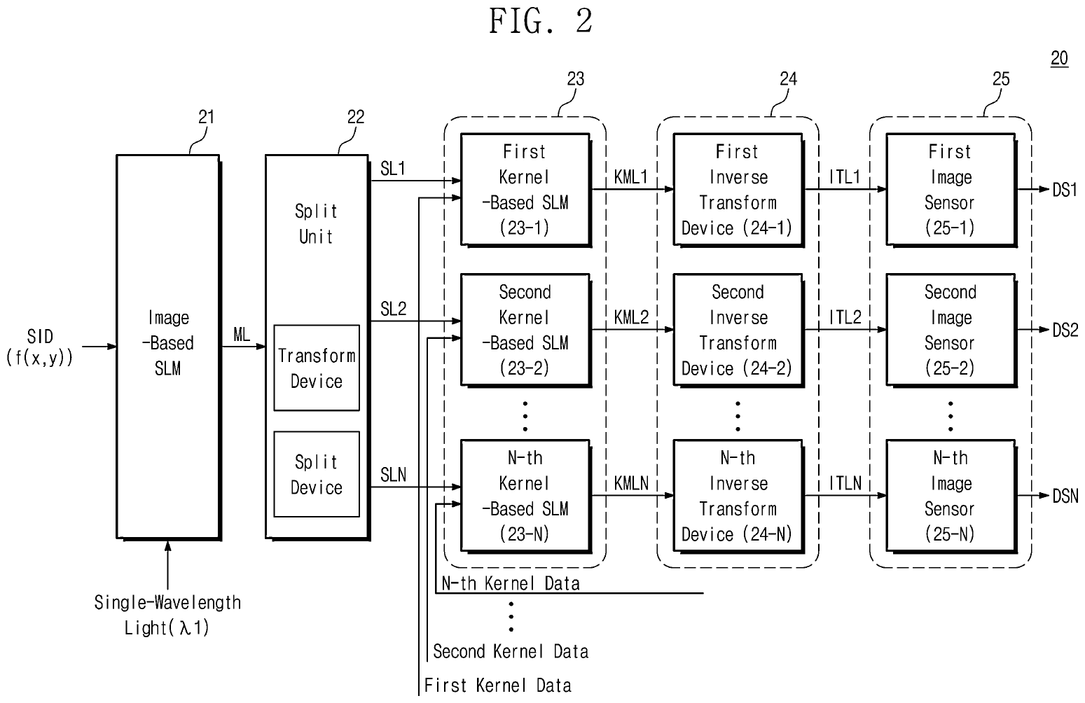

FIG. 2 is a block diagram illustrating a general optical convolutional computing device 20 that performs parallel computing. Referring to FIG. 2, the optical convolutional computing device 20 includes an image-based SLM 21, a split unit 22, a kernel-based SLM unit 23, an inverse transform unit 24, and an image sensor unit 25. The image-based SLM 21 of FIG. 2 corresponds to the image-based SLM 11 of FIG. 1.

The general optical convolutional computing device 20 may perform convolutional computations in parallel for first to N-th kernel data.

First, the image-based SLM 21 may modulate the single-wavelength light having the first wavelength λ1 based on the spatial domain image data f(x, y) to output the modulated light ML.

The split unit 22 may receive the modulated light ML. The split unit 22 may perform the Fourier transform on the modulated light ML and output first to N-th sub-lights SL1 to SLN. The first to N-th sub-lights SL1 to SLN may each contain the same information, such as the modulated light ML. The split unit 22 may include a transform device and a split device. The transform device may correspond to the transform device 12 of FIG. 1. The transform device may perform the Fourier transform on the modulated light ML. The split device may split the modulated light ML or the Fourier-transformed modulated light into N light beams. For example, the split device may include a diffraction grating, a beam splitter, or similar components.

Here, the ‘N’ is a natural number of 2 or more. The operation of performing the Fourier transform on the modulated light ML and the operation of splitting the modulated light ML into the N light beams may be performed either simultaneously or sequentially.

The kernel-based SLM unit 23 may receive the first to N-th sub-lights SL1 to SLN. The kernel-based SLM unit 23 may perform element-wise multiplications based on the first to N-th kernel data and the first to N-th sub-lights SL1 to SLN. The element-wise multiplications may be performed in parallel. For example, the kernel-based SLM unit 23 may perform element-wise multiplication of the first kernel data and the first sub-light SL1 and output first kernel product light KML1. The kernel-based SLM unit 23 may perform the element-wise multiplication of the second kernel data and the second sub-light SL2 and output second kernel product light KML2. This process is repeated for the third to N-th kernel data and the third to N-th sub-lights.

In an embodiment, the kernel-based SLM unit 23 may include first to N-th kernel-based SLMs 23-1 to 23-N. Each of the first to N-th kernel-based SLMs 23-1 to 23-N may correspond to the kernel-based SLM 13 of FIG. 1. The first kernel-based SLM 23-1 may receive the first sub-light SL1, perform the element-wise multiplication based on the first sub-light SL1 and the first kernel data, and output the first kernel product light KML1. The second kernel-based SLM 23-2 may receive the second sub-light SL2, perform the element-wise multiplication based on the second sub-light SL2 and the second kernel data, and output the second kernel product light KML2. The third to N-th kernel-based SLMs 23-3 to 23-N may operate similarly to output the third to N-th kernel product lights KML3 to KMLN, respectively.

In some embodiments, the kernel-based SLM unit may be composed of a single SLM. This SLM may simultaneously receive the first to N-th sub-lights SL1 to SLN and perform modulation operations on the first to N-th sub-lights SL1 to SLN in parallel. In this case, the single SLM may have a larger area and higher resolution than each of the first to N-th kernel-based SLMs 23-1 to 23-N.

The inverse transform unit 24 may perform inverse Fourier transform on the first to N-th kernel product lights KML1 to KMLN, respectively, and output first to N-th inversely transformed lights ITL1 to ITLN.

Specifically, the inverse transform unit 24 may include first to N-th inverse transform devices 24-1 to 24-N. Each of the first to N-th inverse transform devices 24-1 to 24-N may correspond to the inverse transform device 14 of FIG. 1. The first to N-th inverse transform devices 24-1 to 24-N may perform the inverse Fourier transform on the first to N-th kernel product lights KML1 to KMLN, respectively, and output the first to N-th inversely transformed lights ITL1 to ITLN, respectively.

The image sensor unit 25 may sense the first to N-th inversely transformed lights ITL1 to ITLN to generate first to N-th digital signals DS1 to DSN in an image data format.

In some embodiments, the image sensor unit 25 may include first to N-th image sensors 25-1 to 25-N. Each of the first to N-th image sensors 25-1 to 25-N may correspond to the image sensor 15 of FIG. 1. The first image sensor 25-1 may sense the first inversely transformed light ITL1 to generate the first digital signal DS1. The second image sensor 25-2 may sense the second inversely transformed light ITL2 to generate the second digital signal DS2. The third to N-th image sensors 25-3 to 25-N may sense the third to N-th inversely transformed lights to generate the third to N-th digital signals DS3 to DSN, respectively. In this case, output data of the convolutional neural network may be generated by an electronic device that synthesizes the first to N-th digital signals DS1 to DSN. However, there is a concern that additional space and energy are required for the ‘N’ image sensors 25-1 to 25-N.

In some embodiments, the image sensor unit 25 may be composed of a single image sensor. This image sensor may have a larger area and higher resolution than each of the first to N-th image sensors 25-1 to 25-N.

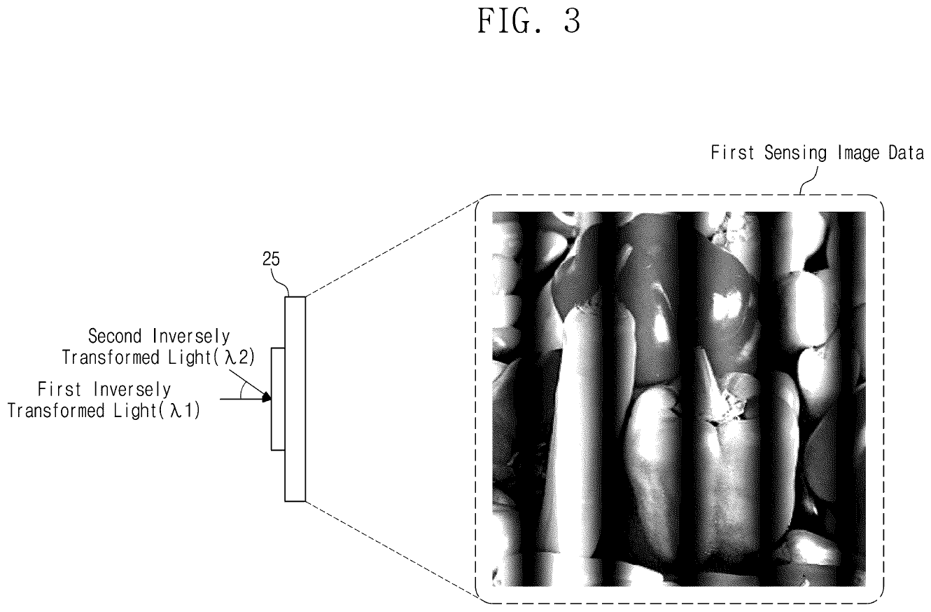

FIG. 3 is a diagram illustrating first sensing image data sensed by an image sensor of FIG. 2. When the image sensor unit 25 of FIG. 2 is composed of a single image sensor, the first sensing image data illustrated in FIG. 3 is generated by the single image sensor.

The wavelengths of the first to N-th inversely transformed lights ITL1 to ITLN may be the same. The image sensor unit 25 may include a sensing plane. The sensing plane may be substantially perpendicular to incident directions of the first to N-th inversely transformed lights ITL 1 to ITLN, and may receive the first to N-th inversely transformed lights ITL 1 to ITLN. Even if the area of the sensing plane of the image sensor unit 25 is sufficiently large to accommodate the first to N-th inversely transformed lights ITL 1 to ITLN incident in parallel, practical image sensors may not capture the first to N-th inversely transformed lights in a completely parallel manner. This is due to spatial discrepancies between the sensing plane and the optical device included in the inverse transform unit 24, as well as variations in the refractive index of air and other factors.

Referring again to FIG. 3, the first inversely transformed light and the second inversely transformed light may incident on the image sensor unit 25 at specific angles.

The amplitude of the image data generated by the image sensor unit 25, based on the first inversely transformed light and the second inversely transformed light, is illustrated in Equation 2.

$$\overline{E ( x , t ) = {A}_{0} {e}^{i ( {k}_{0} r - {ω}_{0} t )} + {B}_{0} {e}^{i ( {k}_{0} r + Δ r ( x ) - {ω}_{0} t )}} \qquad [ Equation 2 ]$$

In this case, E (x, t) refers to the amplitude function of the first sensing image data, A₀ refers to the light amplitude of the first inversely transformed light, B₀ refers to the light amplitude of the second inversely transformed light, k₀ refers to the spatial frequency corresponding to the first wavelength λ₁, “r” refers to the distance from the light source (e.g., the inverse transform unit 24 of FIG. 2) to the origin (x=0) of the image sensor unit 25, Δr(x) refers to the distance difference value between the first inversely transformed light and the second inversely transformed light, and w₀ refers to the angle frequency of the first and second inversely transformed lights.

Furthermore, the image sensor unit 25 may measure the intensity of light incident from a first time t₁ to an exposure time tₛ. As a result, the amplitude of the first sensing image data generated by the image sensor unit 25, based on the light detected between the first time t₁ and the exposure time tₛ, is represented in Equation 3.

$$\text{?} \qquad [ Equation 3 ]$$

$$\text{?} \text{indicates text missing or illegible when filed}$$

Since Δr(x) is linear in x, interference patterns may appear in the first sensing image data. For example, as illustrated in FIG. 3, the first sensing image data may display dark shades that are vertically spaced apart from one another.

For convenience of explanation, the description focuses on sensing only the first and second inversely transformed lights; however, the scope of the present disclosure is not limited thereto. As described above, the image sensor unit 25 may generate sensing image data from three or more lights having the same wavelength, incident at different angles. In this case, the sensing image data may include more interference patterns.

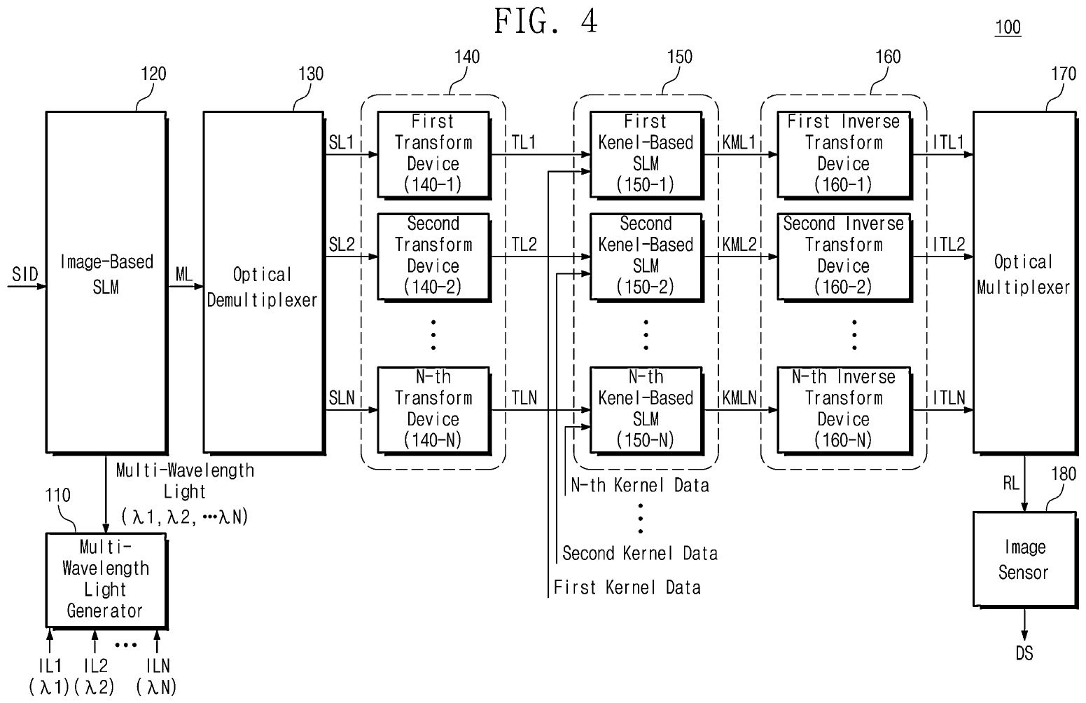

FIG. 4 is a block diagram illustrating an optical convolutional computing device 100 according to an embodiment of the present disclosure. Referring to FIG. 4, the optical convolutional computing device 100 includes a multi-wavelength light generator 110, an image-based SLM 120, an optical demultiplexer 130, a transform unit 140, a kernel-based SLM unit 150, an inverse transform unit 160, an optical multiplexer 170, and an image sensor 180. In an embodiment, the transform unit 140, the kernel-based SLM unit 150, and the inverse transform unit 160 can be integrated into an optical convolution processor.

The multi-wavelength light generator 110 may output multi-wavelength light having first to N-th wavelengths λ1 to λN. For example, the multi-wavelength light generator 110 may receive first to N-th input lights IL1 to ILN. The first to N-th input lights IL1 to ILN may have the first to N-th wavelengths λ1 to λN, respectively. The multi-wavelength light generator 110 may generate coherent multi-wavelength light by synthesizing the first to N-th input lights IL1 to ILN. For example, the multi-wavelength light generator 110 may include at least one optical device, and at least one optical device may output one multi-wavelength light by synthesizing the first to N-th input lights IL1 to ILN.

The image-based SLM 120 may receive spatial domain image data SID. The image-based SLM 120 may output modulated light ML by modulating the multi-wavelength light output from the multi-wavelength light generator 110 based on the spatial domain image data SID.

In some embodiments, the image-based SLM 120 may include one of a transmissive SLM and a reflective SLM, or both.

In some embodiments, the image-based SLM 120 may be included in a digital micro-mirror device (DMD).

For example, the optical convolutional computing device 100 may modulate multi-wavelength light to output the modulated light ML with a waveform of a function corresponding to the spatial domain image data SID by transmitting or reflecting the multi-wavelength light through the image-based SLM 120.

The optical demultiplexer 130 may include at least one optical device. The optical demultiplexer 130 may output first to N-th sub-lights SL1 to SLN based on the input modulated light ML, using at least one optical device. The first to N-th sub-lights SL1 to SLN may have the first to N-th wavelengths λ1 to λN, respectively. In detail, the optical demultiplexer 130 may split the modulated light ML into the first to N-th sub-lights SL1 to SLN, each containing the same information but differing in wavelength.

In some embodiments, the optical demultiplexer 130 may include at least one of a beam splitter, a polarizing beam splitter, or a dichroic mirror.

In some embodiments, the optical multiplexer 170 may include at least one of the diffraction grating or the DMD.

The transform unit 140 may correspond to the transform device of FIG. 2. The transform unit 140 may include first to N-th transform devices 140-1 to 140-N. The first to N-th transform devices 140-1 to 140-N may receive the first to N-th sub-lights SL1 to SLN, respectively. Each of the first to N-th transform devices 140-1 to 140-N may perform the Fourier transform on the first to N-th sub-lights SL1 to SLN, respectively, using at least one optical device. The first to N-th transform devices 140-1 to 140-N may output first to N-th transformed lights TL1 to TLN, respectively.

In some embodiments, each of the first to N-th transform devices 140-1 to 140-N may include at least one lens.

In some embodiments, the relationship between the spatial frequency of the spatial domain image data SID and the coordinates on the Fourier plane of an N-th channel is illustrated in Equation 4.

$$\text{?} \qquad [ Equation 4 ]$$

$$\text{?} \text{indicates text missing or illegible when filed}$$

In this case, kₓ may refer to the horizontal-axis spatial frequency of the spatial domain image data SID, k_{y} may refer to the vertical-axis spatial frequency of the spatial domain image data SID, xₙ′ may refer to the horizontal-axis coordinate on the Fourier plane of the N-th channel, yₙ′ may refer to the vertical-axis coordinate on the Fourier plane of the N-th channel, λₙ may refer to the wavelength of light corresponding to the N-th channel, and f_{1,n} may refer to the focal length of an optical device (e.g., a lens) included in the transform device.

The kernel-based SLM unit 150 may include first to N-th kernel-based SLMs 150-1 to 150-N. The first to N-th kernel-based SLMs 150-1 to 150-N may respectively receive first to N-th kernel data and modulate the first to N-th transformed lights TL1 to TLN based on the first to N-th kernel data to output first to N-th kernel product lights KML1 to KMLN. The first to N-th kernel-based SLMs 150-1 to 150-N may correspond to the first to N-th kernel-based SLMs 23-1 to 23-N of FIG. 2, respectively.

The inverse transform unit 160 may include first to N-th inverse transform devices 160-1 to 160-N. The inverse transform unit 160 may correspond to the inverse transform unit 24 of FIG. 2. The first to N-th inverse transform devices 160-1 to 160-N may receive the first to N-th kernel product lights KML1 to KMLN, respectively. The first to N-th inverse transform devices 160-1 to 160-N may perform the inverse Fourier transform on the first to N-th kernel product lights KML1 to KMLN, respectively, using at least one optical device. The first to N-th inverse transform devices 160-1 to 160-N may output first to N-th inversely transformed lights ITL1 to ITLN, respectively.

In some embodiments, each of the first to N-th transform devices 140-1 to 140-N and the first to N-th inverse transform devices 160-1 to 160-N may include at least one single lens. When N is 3, the relationship between the focal lengths of the single lenses may be illustrated in Equation 5.

$$\text{?} \qquad [ Equation 5 ]$$

$$\text{?} \text{indicates text missing or illegible when filed}$$

In this case, f_{1.1} may refer to the focal length of the lens included in the first transform device 140-1. f_{2.1} may refer to the focal length of the lens included in the first inverse transform device 160-1. f_{1.2} may refer to the focal length of the lens included in the second transform device 140-2. f_{2.2} may refer to the focal length of the lens included in the second inverse transform device 160-2. f_{1.3} may refer to the focal length of the lens included in the third transform device 140-3. f_{2.3} may refer to the focal length of the lens included in the third inverse transform device 160-3.

The optical multiplexer 170 may include at least one optical device. The optical multiplexer 170 may align optical paths of the first to N-th inversely transformed lights ITL1 to ITLN using at least one optical device and output synthesized light RL.

In some embodiments, the optical multiplexer 170 may include at least one of a beam splitter, a polarizing beam splitter, or a dichroic mirror.

In some embodiments, the optical multiplexer 170 may include at least one of the diffraction grating or the DMD.

The image sensor 180 may sense the synthesized light RL. The image sensor 180 may generate a digital signal DS in an image data format based on the light intensity of the synthesized light RL. The digital signal DS may correspond to image data processed by a convolutional neural network using the optical convolutional computing device 100 according to the present disclosure.

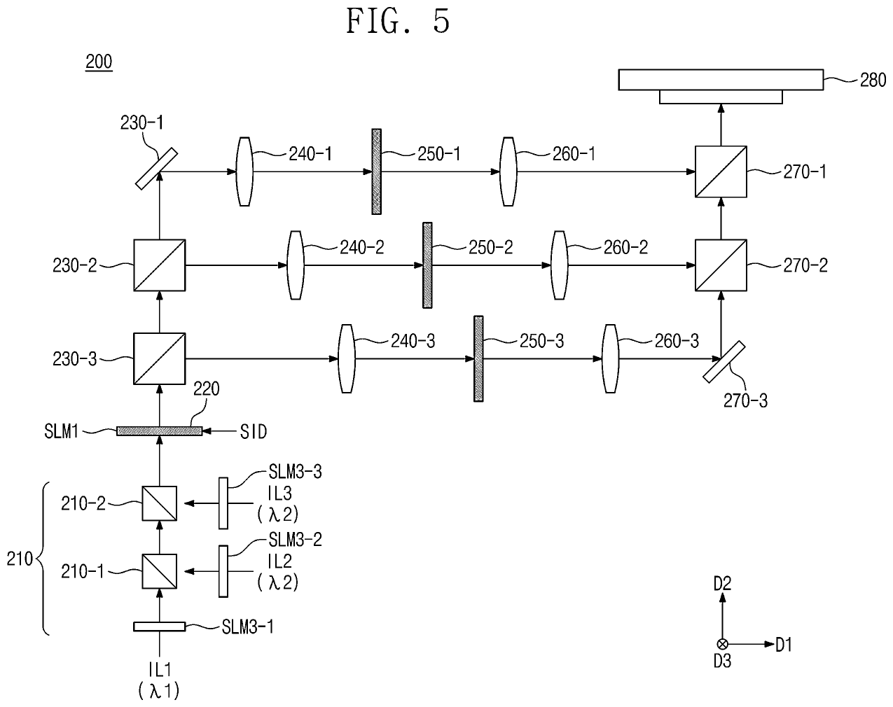

FIG. 5 illustrates an optical convolutional computing device 200 to which a transmissive SLM (spatial light modulator) is applied according to an embodiment of the present disclosure. In the optical convolutional computing device 200, at least one of an image-based SLM or a kernel-based SLMs is the transmissive SLM. FIG. 5 illustrates a plan view formed by a first direction D1 and a second direction D2 perpendicular to the first direction D1, and a third direction D3 may represent a direction perpendicular to both the first direction D1 and the second direction D2.

For convenience of explanation, a case where “N” is 3 is illustrated, but the scope of the present disclosure is not limited thereto. The optical convolutional computing device 200 may operate similarly even when “N” is 2 or greater than 3. In addition, components illustrated in FIG. 5 may each correspond to those with similar reference numbers (e.g., when the latter part of the reference numbers is the same) in FIG. 4.

A multi-wavelength light generator 210 may align optical paths of first to third input lights IL1 to IL3. In detail, the multi-wavelength light generator 210 may synthesize the first to third input lights IL1 to IL3 to output multi-wavelength light.

The multi-wavelength light generator 210 may include an optical device 210-1 that aligns the optical path of the second input light IL2 with the optical path of the first input light IL1.

For example, the optical device 210-1 may transmit the first input light IL1 as it is in the second direction D2, and may output the second input light IL2 in the second direction D2, which is the direction of the optical path of the first input light IL1.

The multi-wavelength light generator 210 may further include an optical device 210-2 that aligns the optical path of the third input light IL3 with the optical path of the first input light IL1.

For example, the optical device 210-2 may transmit the light output from the optical device 210-1 as it is in the second direction D2, and may output the third input light IL3 in the second direction D2, which is the direction of the optical path of the first input light IL1.

Therefore, the multi-wavelength light generator 210 may generate the first to third input lights IL1 to IL3 with aligned optical paths (i.e., synthesized) as the multi-wavelength light.

In some embodiments, the first to third input lights IL1 to IL3 may have first to third weight values applied, respectively. The first to third weight values may be included in weight data of a convolutional neural network using the convolutional computing device according to the present disclosure.

For example, the multi-wavelength light generator 210 may further include first to third weight-based SLMs SLM3-1 to SLM3-3. The first to third weight-based SLMs SLM3-1 to SLM3-3 may modulate the angle frequencies of the first to third input lights IL1 to IL3 based on the first to third weight values, respectively.

However, the scope of the present disclosure is not limited thereto, and the first to third input lights IL1 to IL3 input to the optical convolutional computing device 200 may be modulated based on the first to third weight values at any stage before being synthesized in an optical multiplexer.

An image-based SLM1220 may transmit the multi-wavelength light incident in the second direction D2. In detail, the image-based SLM1220 may modulate the multi-wavelength light based on spatial domain image data SID, and may transmit the modulated light in the second direction D2.

An optical demultiplexer may include a plurality of optical devices 230-1 to 230-3. The plurality of optical devices 230-1 to 230-3 may split the modulated light incident in the second direction D2 into first to third sub-lights, each based on its wavelength, and may output the first to third sub-lights in the first direction D1.

Specifically, the plurality of optical devices 230-1 to 230-3 may be arranged parallel to each other in the second direction D2. The optical device 230-3 may receive the modulated light in the second direction D2, output a component (i.e., light) corresponding to a third wavelength 23 of the modulated light as the third sub-light in the first direction D1, and output the remaining components (e.g., components corresponding to first and second wavelengths λ1 and 22 of the modulated light) in the second direction D2. The optical device 230-2 may output a component corresponding to the second wavelength λ2 of the light received from the optical device 230-3 as the second sub-light in the first direction D1, and output the remaining component (e.g., a component corresponding to the first wavelength λ1 of the modulated light) in the second direction D2. The optical device 230-1 may output the light (e.g., a component corresponding to the first wavelength λ1 of the modulated light) received from the optical device 230-2 as the first sub-light in the first direction D1.

In some embodiments, each of the plurality of optical devices 230-1 to 230-3 may include at least one of a beam splitter, a polarizing beam splitter, or a dichroic mirror.

In the embodiment shown in FIG. 5, the optical device 230-1 includes a dichroic mirror, and each of the remaining optical devices 230-2 and 230-3 includes a beam splitter or a polarizing beam splitter.

The first sub-light output from the optical device 230-1 may pass through a first transform device 240-1, a first kernel-based SLM 250-1, and a first inverse transform device 260-1 arranged parallel to each other in the first direction D1.

For example, the first kernel-based SLM 250-1 may be a transmissive SLM. The first kernel-based SLM 250-1 may perform element-wise multiplication on first transformed light output from the first transform device 240-1 based on first kernel data and output first kernel product light in the first direction D1.

The second sub-light output from the optical device 230-2 may pass through a second transform device 240-2, a second kernel-based SLM 250-2, and a second inverse transform device 260-2 arranged parallel to each other in the first direction D1.

For example, the second kernel-based SLM 250-2 may be a transmissive SLM. The second kernel-based SLM 250-2 may perform element-wise multiplication on second transformed light output from the second transform device 240-2 based on second kernel data and output second kernel product light in the second direction D2.

The third sub-light output from the optical device 230-3 may pass through a third transform device 240-3, a third kernel-based SLM 250-3, and a third inverse transform device 260-3 arranged parallel to each other in the first direction D1.

For example, the third kernel-based SLM 250-3 may be a transmissive SLM. The third kernel-based SLM 250-3 may perform element-wise multiplication on third transformed light output from the third transform device 240-3 based on third kernel data and output third kernel product light in the first direction D1.

The optical multiplexer may include a plurality of optical devices 270-1 to 270-3.

For example, the plurality of optical devices 270-1 to 270-3 may change optical paths of first to third inversely transformed lights, which are respectively incident in the first direction D1. In detail, the optical multiplexer may change the optical paths of the first to third inversely transformed lights to align with a direction (e.g., the second direction D2) different from the first direction D1 so as to be synthesized. The optical multiplexer may output synthesized light in a direction (e.g., the second direction D2) different from the first direction D1. In detail, the synthesized light may refer to the light synthesized from the first to third inversely transformed lights.

The optical device 270-3 may be arranged parallel to the third inverse transform device 260-3 in the first direction D1. The optical device 270-3 may receive the third inversely transformed light in the first direction D1 and output the third inversely transformed light in the second direction D2.

The optical device 270-2 may be arranged parallel to the second inversely transform device 260-2 in the first direction D1 and parallel to the optical device 270-3 in the second direction D2. The optical device 270-2 may receive the second inversely transformed light in the first direction D1 and output the second inversely transformed light in the second direction D2. In addition, the optical device 270-2 may pass the third inversely transformed light, input in the second direction D2, along the same direction D2. In detail, the optical device 270-2 may align the optical paths of the second and third inversely transformed lights.

The optical device 270-1 may be arranged parallel to the first inverse transform device 260-1 in the first direction D1 and parallel to the optical device 270-2 in the second direction D2. The optical device 270-1 may receive the first inversely transformed light in the first direction D1 and output the first inversely transformed light in the second direction D2. In addition, the optical device 270-1 may pass the second and third inversely transformed lights, input in the second direction D2, in the second direction D2. In detail, the optical device 270-1 may align the optical path of the first inversely transformed light with the optical paths of the second and third inversely transformed lights.

In some embodiments, each of the plurality of optical devices 270-1 to 270-3 may include at least one of a beam splitter, a polarizing beam splitter, or a dichroic mirror.

In detail, the optical multiplexer may output the first to third inversely transformed lights, whose optical paths are aligned with each other, as the synthesized light in the second direction D2.

An image sensor 280 may be arranged in parallel to the plurality of optical devices 270-1 to 270-3 in the second direction D2. The image sensor 280 may sense the synthesized light.

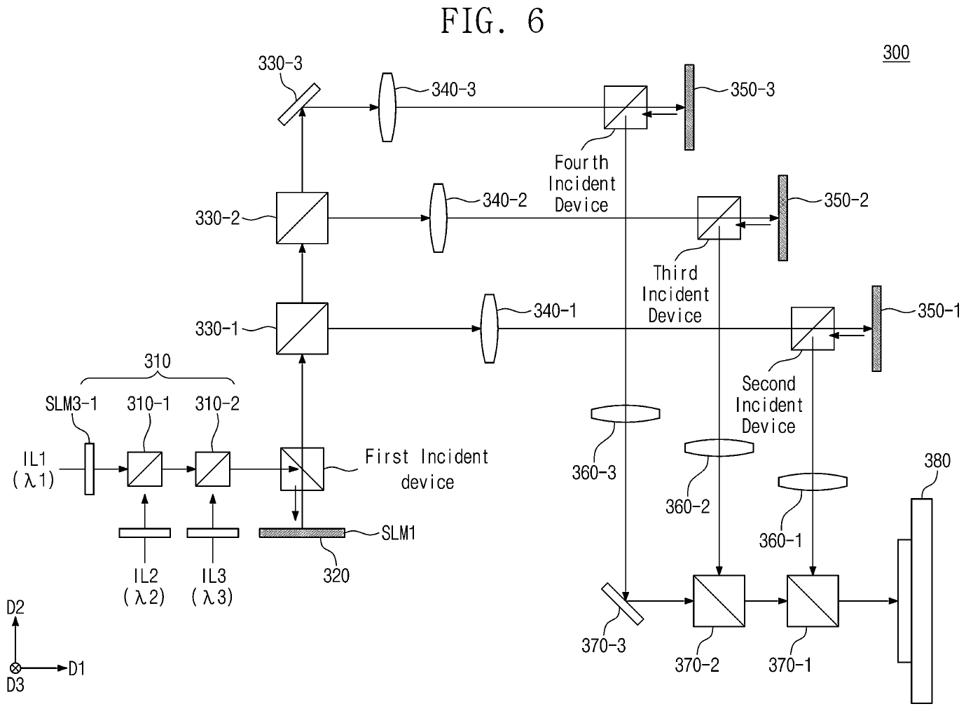

FIG. 6 illustrates an optical convolutional computing device 300 to which a reflective SLM is applied according to an embodiment of the present disclosure. In the optical convolutional computing device 300, at least one of an image-based SLM and a kernel-based SLM is the reflective SLM. FIG. 6 is a plan view formed by a first direction D1 and a second direction D2 perpendicular to the first direction D1, and a third direction D3 may represent a direction perpendicular to both the first direction D1 and the second direction D2.

For convenience of explanation, a case where “N” is 3 is illustrated, but the scope of the present disclosure is not limited thereto. The optical convolutional computing device 300 may operate similarly even when “N” is 2 or greater than 3. In addition, components illustrated in FIG. 6 may each correspond to those with similar reference numbers (e.g., when the latter part of the reference numbers is the same) in FIG. 4.

A multi-wavelength light generator 310 may correspond to the multi-wavelength light generator 210 of FIG. 5. The multi-wavelength light generator 310 may receive first input light IL1 in the first direction D1, and may receive second and third input lights IL2 and IL3 in the second direction D2. The multi-wavelength light generator 310 may change optical paths of the second and third input lights IL2 and IL3 to align with the first direction D1.

The optical convolutional computing device 300 may further include a first incident device. The first incident device may allow multi-wavelength light output from the multi-wavelength light generator 310 to be incident on an image-based SLM 320, and may allow the light reflected from the image-based SLM 320 to be output to an optical demultiplexer without overlapping with the optical path of the multi-wavelength light.

For example, the first incident device may include at least one of a beam splitter, a polarizing beam splitter, or a dichroic mirror. The first incident device may be arranged parallel to the multi-wavelength light generator 310 in the first direction D1. The first incident device may receive the multi-wavelength light in the first direction D1 and output the multi-wavelength light to the image-based SLM 320 in an opposite direction of the second direction D2. In addition, the first incident device may transmit modulated light reflected from the image-based SLM 320 in the second direction D2 and output the modulated light to the optical demultiplexer.

The optical demultiplexer may include a plurality of optical devices 330-1 to 330-3. The plurality of optical devices 330-1 to 330-3 may be arranged parallel to the first incident device in the second direction D2.

The optical device 330-1 may receive the light modulated in the second direction D2. The optical device 330-1 may output a component corresponding to the first wavelength λ₁ of the modulated light as the first sub-light in the first direction D1, and may output the remaining components in the second direction D2.

The optical device 330-2 may receive the light transmitted from the optical device 330-1 in the second direction D2. The optical device 330-2 may output a component corresponding to the second wavelength λ2 of the input light as the second sub-light in the first direction D1, and may output the remaining component in the second direction D2.

The optical device 330-3 may receive the light transmitted from the optical device 330-2 in the second direction D2 and output the received light as the third sub-light in the first direction D1.

The first sub-light may be incident on a first kernel-based SLM 350-1 through a first transform device 340-1 and a second incident device. The second incident device is arranged parallel to the optical device 330-1 in the first direction D1. The second incident device may output first transformed light output from the first transform device 340-1 as it is to the first kernel-based SLM 350-1, and may output first kernel product light reflected from the first kernel-based SLM 350-1 in a different direction (e.g., an opposite direction of the second direction D2) so as not to overlap with the optical path of the first transformed light. Subsequently, the first kernel product light may be incident on the optical multiplexer through a first inverse transform device 360-1 arranged parallel to the second incident device.

The second sub-light may be incident on a second kernel-based SLM 350-2 through a second transform device 340-2 and a third incident device. The third incident device is arranged parallel to the optical device 330-2 in the first direction D1. The third incident device may output second transformed light output from the second transform device 340-2 as it is to the second kernel-based SLM 350-2, and may output second kernel product light reflected from the second kernel-based SLM 350-2 in a different direction (e.g., an opposite direction of the second direction D2) so as not to overlap with the optical path of the second transformed light. Subsequently, the second kernel product light may be incident on the optical multiplexer through a second inverse transform device 360-2 arranged parallel to the third incident device.

The third sub-light may be incident on a third kernel-based SLM 350-3 through a third transform device 340-3 and a fourth incident device. The fourth incident device is arranged parallel to the optical device 330-3 in the first direction D1. The fourth incident device may output third transformed light output from the third transform device 340-3 as it is to the third kernel-based SLM 350-3, and may output third kernel product light reflected from the third kernel-based SLM 350-3 in a different direction (e.g., an opposite direction of the second direction D2) so as not to overlap with the optical path of the third transformed light. Subsequently, the third kernel product light may be incident on the optical multiplexer through a third inverse transform device 360-3 arranged parallel to the fourth incident device.

In some embodiments, each of the second to fourth incident devices may include at least one of a beam splitter, a polarizing beam splitter, or a dichroic mirror.

The optical multiplexer may include a plurality of optical devices 370-1 to 370-3.

The optical device 370-3 may reflect third inversely transformed light incident in the opposite direction of the second direction D2 and output the third inversely transformed light in the first direction D1.

The optical device 370-2 may receive second inversely transformed light incident in the opposite direction of the second direction D2 and output the second inversely transformed light in the first direction D1, and may receive the third inversely transformed light incident in the first direction D1 and output the third inversely transformed light as it is in the first direction D1. In detail, the optical device 370-2 may align the optical path of the second inversely transformed light with the optical path of the third inversely transformed light.

The optical device 370-1 may receive first inversely transformed light incident in the opposite direction of the second direction D2 and output the first inversely transformed light in the first direction D1, and may receive the second and third inversely transformed lights incident in the first direction D1 and output second and third inversely transformed lights as they are in the first direction D1. In detail, the optical device 370-1 may align the optical path of the first inversely transformed light with the optical paths of the second and third inversely transformed lights.

The optical multiplexer may output the first to third inversely transformed lights, with their optical paths aligned, as synthesized light in the first direction D1.

An image sensor 380 may be arranged parallel to the optical multiplexer in the first direction D1. The image sensor 380 may sense the synthesized light incident in the first direction D1.

In some embodiments, the reflective SLM may further use a polarizing plate or a wavelength plate.

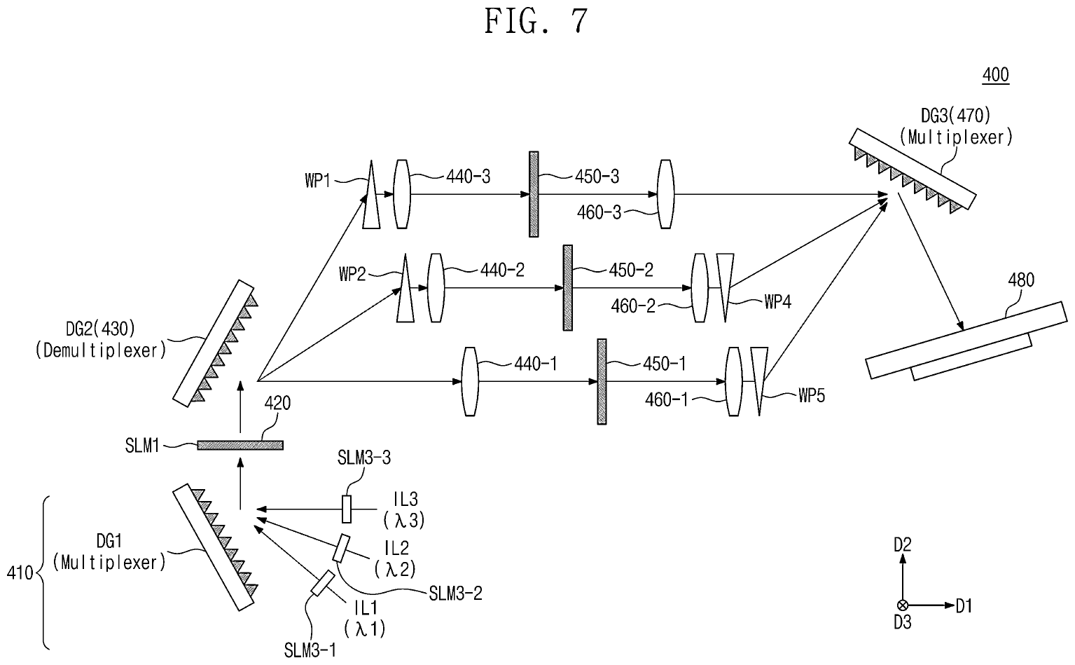

FIG. 7 illustrates an optical convolutional computing device 400 to which a diffraction grating is applied according to an embodiment of the present disclosure. Referring to FIG. 7, the optical convolutional computing device 400 uses at least one diffraction grating. FIG. 7 illustrates a plan view formed by a first direction D1 and a second direction D2 perpendicular to the first direction D1, and a third direction D3 may represent a direction perpendicular to both the first direction D1 and the second direction D2.

For convenience of explanation, a case where “N” is 3 is illustrated, but the scope of the present disclosure is not limited thereto. The optical convolutional computing device 400 may operate similarly even when “N” is 2 or greater than 3. In addition, components illustrated in FIG. 7 may each correspond to those with similar reference numbers (e.g., when the latter part of the reference numbers is the same) in FIG. 4.

A multi-wavelength light generator 410 may include a first diffraction grating DG1. The first diffraction grating DG1 may change optical paths of first to third input lights IL1 to IL3 incident in different directions into one direction (e.g., the second direction D2). In detail, the first diffraction grating DG1 may synthesize (or combine) the first to third input lights IL1 to IL3 and output the synthesized light as multi-wavelength light in the second direction D2.

In some embodiments, the first to third input lights IL1 to IL3 may be lights to which first to third weight values are applied, respectively. The first to third weight values may be included in weight data of a convolutional neural network using a convolutional computing device according to the present disclosure.

For example, the multi-wavelength light generator 410 may further include first to third weight-based SLMs SLM3-1 to SLM3-3. The first to third weight-based SLMs SLM3-1 to SLM3-3 may modulate the angle frequencies of the first to third input lights IL1 to IL3 based on the first to third weight values, respectively.

However, the scope of the present disclosure is not limited thereto, and the first to third input lights IL1 to IL3 input to the optical convolutional computing device 400 may be modulated based on the first to third weight values at any stage before being synthesized in an optical multiplexer.

An image-based SLM 420 may correspond to the image-based SLM 120 of FIG. 4. The image-based SLM 420 may modulate the multi-wavelength light and output the modulated light in the second direction D2.

An optical demultiplexer 430 may include a second diffraction grating DG2. The second diffraction grating DG2 may output the modulated light incident in the second direction D2 as first to third sub-lights in three different directions for each of first to third wavelengths λ1 to λ3. For example, the second diffraction grating DG2 may output the first sub-light in the first direction D1. The second diffraction grating DG2 may output the second and third sub-lights in directions different from the first direction D1.

The optical convolutional computing device 400 may further include a first prism WP1 and a second prism WP2. The first prism WP1 may change the optical path of the third sub-light to the first direction D1. The second prism WP2 may change the optical path of the second sub-light to the first direction D1.

The first sub-light may sequentially pass through a first transform device 440-1, a first kernel-based SLM 450-1, and a first inverse transform device 460-1 arranged in parallel in the first direction D1. The second sub-light passing through the second prism WP2 may sequentially pass through a second transform device 440-2, a second kernel-based SLM 450-2, and a second inverse transform device 460-2 arranged in parallel in the first direction D1. The third sub-light passing through the first prism WP1 may sequentially pass through a third transform device 440-3, a third kernel-based SLM 450-3, and a third inverse transform device 460-3 arranged in parallel in the first direction D1.

In some embodiments, the second diffraction grating DG2 may output the first sub-light in a fourth direction different from the first direction D1. In such a case, the optical convolutional computing device 400 may include the first to third prisms (however, the third prism is not illustrated in FIG. 7). The first to third prisms may receive the first to third sub-lights in three different directions, respectively, and may change the optical paths of the first to third sub-lights to the first direction D1.

An optical multiplexer 470 may include a third diffraction grating DG3. The third diffraction grating DG3 may align the optical paths of first to third inversely transformed lights, which are incident from different directions, into a single direction so as to be output as synthesized light.

In detail, for example, the third diffraction grating DG3 may receive the third inversely transformed light in the first direction D1. The third diffraction grating DG3 may receive the first and second inversely transformed lights in directions other than the first direction D1, respectively.

In this case, the optical convolutional computing device 400 may further include a fourth prism WP4 and a fifth prism WP5. The fourth prism WP4 may change the optical path of the second inversely transformed light so as to be incident on the third diffraction grating DG3 such that the second inversely transformed light may be synthesized with the third inversely transformed light. The fifth prism WP5 may change the optical path of the first inversely transformed light so as to be incident on the third diffraction grating DG3 such that the first inversely transformed light may be synthesized with the third inversely transformed light.

An image sensor 480 may include a sensing plane. The sensing plane may be arranged to be perpendicular to the synthesized light. The image sensor 480 may sense the light intensity of the synthesized light through the sensing plane.

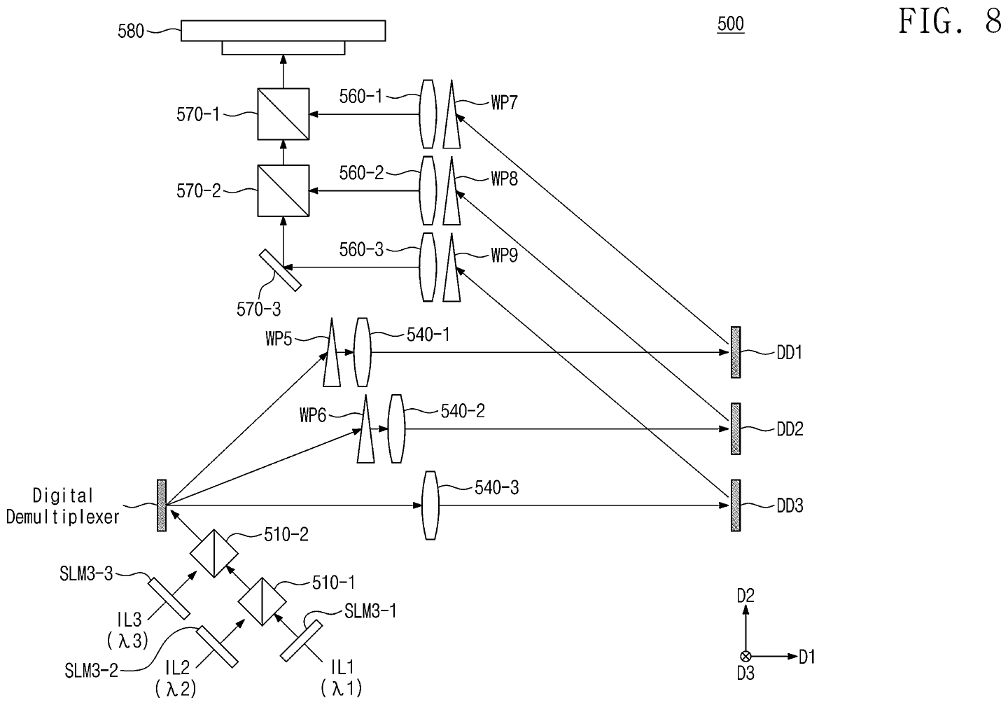

FIG. 8 illustrates an optical convolutional computing device 500 to which a digital device is applied according to an embodiment of the present disclosure.

Referring to FIG. 8, the optical convolutional computing device 500 uses at least one digital device. FIG. 8 illustrates a plan view formed by a first direction D1 and a second direction D2 perpendicular to the first direction D1, and a third direction D3 may represent a direction perpendicular to both the first direction D1 and the second direction D2.

For convenience of explanation, a case where “N” is 3 is illustrated, but the scope of the present disclosure is not limited thereto. The optical convolutional computing device 500 may operate similarly even when “N” is 2 or greater than 3. In addition, components illustrated in FIG. 8 may each correspond to those with similar reference numbers (e.g., when the latter part of the reference numbers is the same) in FIG. 4.

A multi-wavelength light generator 510 may correspond to the multi-wavelength light generator 210 of FIG. 5. The multi-wavelength light generator 510 may output multi-wavelength light to a digital demultiplexer by aligning the optical paths of first to third input lights IL1 to IL3.

The digital demultiplexer may receive the multi-wavelength light in any direction. The digital demultiplexer may modulate the multi-wavelength light based on spatial domain image data. In addition, the digital demultiplexer may output the modulated multi-wavelength light as first to third sub-lights in three different directions, respectively.

In detail, for example, the digital demultiplexer may output the third sub-light in the first direction D1. The digital demultiplexer may output the first and second sub-lights in directions different from the first direction D1, respectively.

In some embodiments, the digital demultiplexer may include a DMD (digital micro-mirror device).

The optical convolutional computing device 500 may further include a fifth prism WP5 and a sixth prism WP6. The fifth prism WP5 may change the optical path of the first sub-light to the first direction D1. The sixth prism WP6 may change the optical path of the second sub-light to the first direction D1.

The first sub-light may pass through a first transform device 540-1 arranged parallel to the fifth prism WP5 in the first direction D1 and may be incident on a first digital device DD1. The first digital device DD1 may receive first transformed light output from the first transform device 540-1 in the first direction D1. The first digital device DD1 may modulate the first transformed light to correspond to the element-wise multiplication that is based on first kernel data. The first digital device DD1 may output first kernel product light in a direction (e.g., a fourth direction) different from the first direction D1.

The second sub-light may pass through a second transform device 540-2 arranged parallel to the sixth prism WP6 in the first direction D1 and may be incident on a second digital device DD2. The second digital device DD2 may receive second transformed light output from the second transform device 540-2 in the first direction D1. The second digital device DD2 may modulate the second transformed light to correspond to the element-wise multiplication that is based on second kernel data. The second digital device DD2 may output second kernel product light in a direction (e.g., the fourth direction) different from the first direction D1.

The third sub-light may pass through a third transform device 540-3, which is arranged parallel to the digital demultiplexer, in the first direction D1, and may be incident on a third digital device DD3. The third digital device DD3 may receive third transformed light output from the third transform device 540-3 in the first direction D1. The third digital device DD3 may modulate the third transformed light to correspond to the element-wise multiplication that is based on third kernel data. The third digital device DD3 may output third kernel product light in a direction (e.g., the fourth direction) different from the first direction D1.

The optical convolutional computing device 500 may further include seventh to ninth prisms WP7 to WP9. The seventh to ninth prisms WP7 to WP9 may align the optical paths of the first to third kernel product lights to the same direction. The optical paths of the first to third kernel product lights do not overlap each other.

For example, the seventh prism WP7 may change the optical path of the first kernel product light to the opposite direction of the first direction D1. The eighth prism WP8 may change the optical path of the second kernel product light to the opposite direction of the first direction D1. The ninth prism WP9 may change the optical path of the third kernel product light to the opposite direction of the first direction D1.

Furthermore, a first inverse transform device 560-1 is arranged parallel to the seventh prism WP7 in the first direction D1 and may pass the first kernel product light incident in the opposite direction of the first direction D1 through the seventh prism WP7. A second inverse transform device 560-2 is arranged parallel to the eighth prism WP8 in the first direction D1 and may pass the second kernel product light incident in the opposite direction of the first direction D1 through the eighth prism WP8. A third inverse transform device 560-3 is arranged parallel to the ninth prism WP9 in the first direction D1 and may pass the third kernel product light incident in the opposite direction of the first direction D1 through the ninth prism WP9.

The optical multiplexer may include a plurality of optical devices 570-1 to 570-3. The optical multiplexer may output synthesized light by aligning the optical paths of first to third inversely transformed lights using the plurality of optical devices 570-1 to 570-3. The optical multiplexer may correspond to the optical multiplexer of FIG. 5.

For example, the optical multiplexer may align the optical paths of the first to third inversely transformed lights in the second direction D2 and may output the synthesized light in the second direction D2.

An image sensor 580 may sense the light intensity of the synthesized light incident in the second direction D2.

For convenience of explanation, the description is based on the embodiments illustrated in FIGS. 5 to 8, but the scope of the present disclosure is not limited thereto. The optical paths may vary from those described, provided that the light paths do not overlap. Additionally, some configurations for altering the optical paths may be added or omitted.

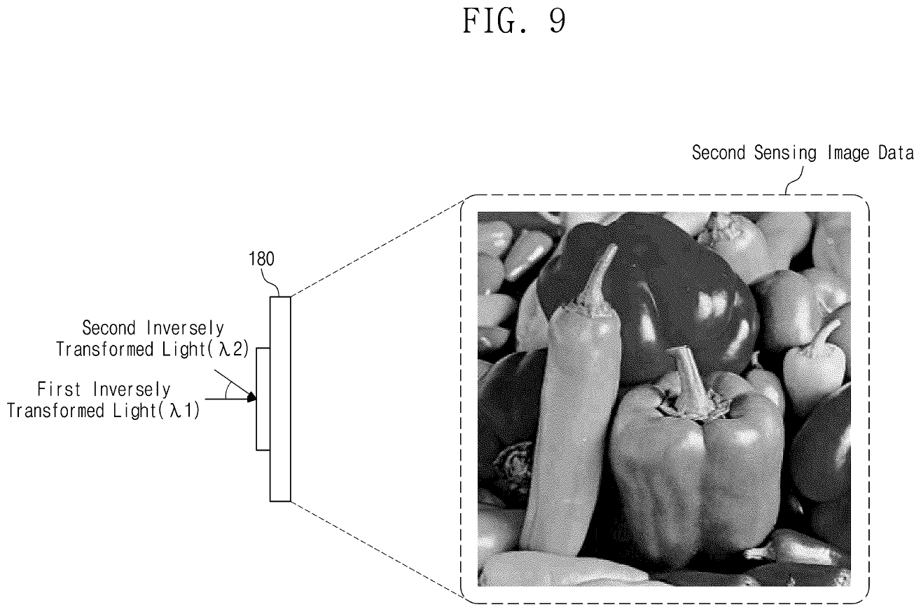

FIG. 9 is a drawing for describing sensing image data sensed by the image sensor 180 of FIG. 4. Referring to FIG. 9, second sensed image data generated by the image sensor 180 is illustrated.

First, in FIG. 4, the wavelengths of the first to N-th inversely transformed lights ITL1 to ITLN may correspond to the first to N-th wavelengths λ1 to ΔN, respectively. As shown in FIG. 4, the image sensor 180 may include a sensing plane. Even if the sensing plane is large enough to accommodate the first to N-th inversely transformed lights in parallel, the actual image sensor 180 may not allow the first to N-th inversely transformed lights to be incident perfectly parallel to the sensing plane of the image sensor 180 due to factors such as spatial misalignment between the sensing plane and the optical device included in the inverse transform unit 160, variations in the refractive index of air, and similar factors.

Referring again to FIG. 9, the first inversely transformed light and the second inversely transformed light may be incident on the image sensor 180 at a specific angle.

The amplitude of the second sensing image data generated by the image sensor 180, based on the first inversely transformed light and the second inversely transformed light, is illustrated in Equation 6.

$$E ( x , t ) = {A}_{1} {e}^{i ( {k}_{1} r - {ω}_{1} t )} + {A}_{2} {e}^{i ( {k}_{2} r + Δ r ( x ) - {ω}_{2} t )} \qquad [ Equation 6 ]$$

In this case, E (x, t) refers to the amplitude function of the second sensing image data, A1 refers to the optical amplitude of the first inversely transformed light, A₂ refers to the optical amplitude of the second inversely transformed light, k₁ refers to the spatial frequency corresponding to the first wavelength λ₁, k₂ refers to the spatial frequency corresponding to the second wavelength λ₂, “r” refers to the distance from the light source (e.g., the optical multiplexer of FIG. 5) to the origin (x=0) of the image sensor 180, Δr(x) refers to the distance difference value between the first inversely transformed light and the second inversely transformed light, w₁ refers to the angle frequency of the first inversely transformed light, and w₂ refers to the angle frequency of the second inversely transformed light.

Furthermore, the image sensor 180 may measure the intensity of light incident from the first time t₁ to the exposure time tₛ. As a result, the function representing the amplitude of the second sensing image data generated by sensing the light incident on the image sensor 180 from the start time to t₀ the exposure time tₛ is illustrated in Equation 7.

$$\text{?} \qquad [ Equation 7 ]$$

$$\text{?} \text{indicates text missing or illegible when filed}$$

When the wavelengths of the first inversely transformed light and the second inversely transformed light are different, a beat phenomenon may occur when the first inversely transformed light and the second inversely transformed light overlap. In this case, it can be assumed that the beat period is hundreds to billions of times shorter than the exposure time tₛ.

Therefore, since

2A₁A₂∫ₜ₀^{t0+t2} cos((k₁−k₂)r−k₂Δr(x)−(w₁−w₂)t)dt

is considerably smaller than

∫ₜ₀^{t0+t3}(A₁₂+A₂₂)dt,

Equation 7 may be approximated as Equation 8.

$$\text{?} \qquad [ Equation 8 ]$$

$$\text{?} \text{indicates text missing or illegible when filed}$$

In this case, the amplitude function of the second sensing image data sensed by the image sensor 180 is represented in Equation 9.

$$\text{?} \qquad [ Equation 9 ]$$

$$\text{?} \text{indicates text missing or illegible when filed}$$

In this case, x″ indicates a horizontal axis coordinate on the sensing plane of the image sensor, and y″ indicates a vertical axis coordinate on the sensing plane of the image sensor.

Therefore, unlike the first sensing image data of FIG. 3, the second sensing image data may not have an interference pattern.

In detail, the optical convolutional computing device according to the present disclosure may synthesize the operation results (inversely transformed lights) using an optical multiplexer while performing computations on a plurality of kernel data in parallel. Therefore, the optical convolutional computing device may reduce the area or energy consumption by the image sensor or may reduce the amount of computation of an electronic computer while performing a plurality of computations in parallel.

For convenience of explanation, the case of sensing only the first and

second inversely transformed lights is described, but the scope of the present disclosure is not limited thereto. As in the above description, the image sensor may generate sensing image data from three or more lights having the same wavelength and incident at different angles. In this case, the sensing image data may include more interference patterns.

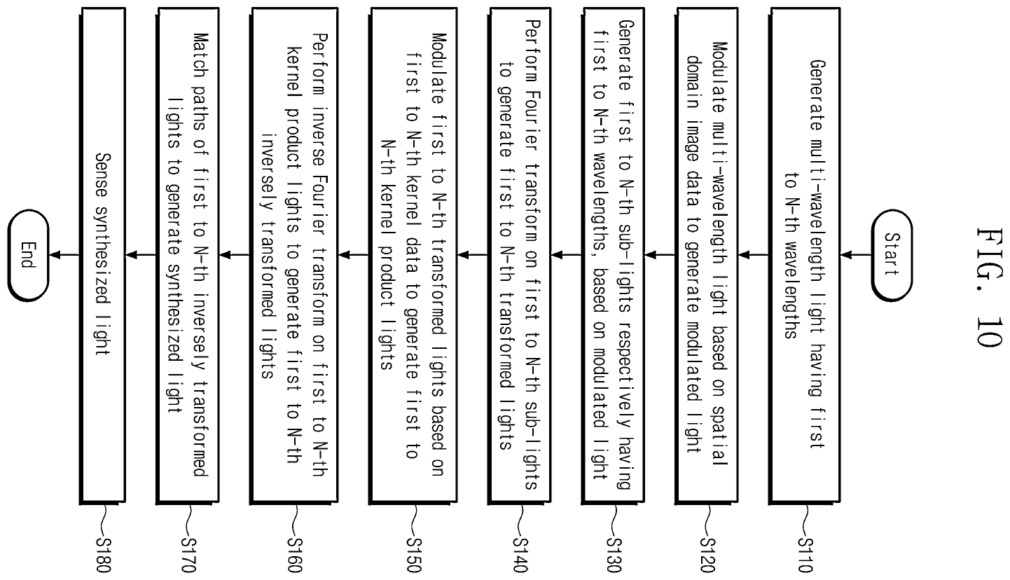

FIG. 10 is a flowchart illustrating an operation of an optical convolutional computing device according to an embodiment of the present disclosure. Referring to FIG. 10, a method of operating the optical convolutional computing device 100 of FIG. 4 is described in flow. The optical convolutional computing device may include a multi-wavelength light generator, an image-based SLM, an optical demultiplexer, first to N-th transform devices, first to N-th kernel-based SLMs, first to N-th inverse transform devices, an optical multiplexer, and an image sensor.

In S110, the optical convolutional computing device may generate the multi-wavelength light having the first to N-th wavelengths, by the multi-wavelength light generator.

In S120, the optical convolutional computing device may modulate the multi-wavelength light based on the spatial domain image data and output the modulated light, by the image-based SLM.

In S130, the optical convolutional computing device may output the first to N-th sub-lights respectively having the first to N-th wavelengths, based on the modulated light, using at least one optical device, by the optical demultiplexer.

In S140, the optical convolutional computing device may perform Fourier transform on the first to N-th sub-lights, respectively, using at least one optical device and output the first to N-th transformed lights, respectively, by the first to N-th transform devices.

In S150, the optical convolutional computing device may modulate the first to N-th transformed lights, respectively, based on the first to N-th kernel data respectively and output the first to N-th kernel product lights, respectively, by the first to N-th kernel-based SLMs.

In S160, the optical convolutional computing device may perform inverse Fourier transform on the first to N-th kernel product lights, respectively, using at least one optical device and output the first to N-th inversely transformed lights, by the first to N-th inverse transform devices.

In S170, the optical convolutional computing device may align the paths of the first to N-th inversely transformed lights using at least one optical device and output the synthesized light, by the optical multiplexer.

In S180, the optical convolutional computing device may sense the synthesized light, by the image sensor.

According to the embodiments of the present disclosure, the optical convolutional computing devices and the method of operating the same are provided.

In addition, the optical convolutional computing device and the operating method thereof are provided, which perform computing in parallel by applying a plurality of kernels based on a multi-wavelength light source and optically synthesize the results of the convolutional computing, thereby improving the performance of the computation and increasing energy efficiency.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. An optical convolutional computing device, comprising:
an image-based spatial light modulator (SLM) configured to modulate a multi-wavelength light based on aspatial domain image data, and output modulated light;
an optical demultiplexer configured to output first to N-th sub-lights having first to N-th wavelengths, respectively, based on the modulated light;
an optical convolution processor configured to receive the first to N-th sub-lights and output first to N-th inversely transformed lights; and
an optical multiplexer configured to align paths of the first to N-th inversely transformed lights;
wherein N is a natural number greater than or equal to 2.

2. The optical convolution computing device of claim 1, further comprising:
a multi wavelength light generator configured to output multi-wavelength light having first to N-th wavelengths.

3. The optical convolution computing device of claim 1, further comprising:
an image sensor configured to sense the synthesized light.

4. The optical convolution computing device of claim 1, further comprising:
a multi wavelength light generator configured to output multi-wavelength light having first to N-th wavelengths; and
an image sensor configured to sense the synthesized light,
wherein the optical convolution processor includes:
first to N-th transform devices configured to perform Fourier transform on the first to N-th sub-lights, respectively, and to output first to N-th transformed lights, respectively;
first to N-th kernel-based SLMs configured to respectively receive first to N-th kernel data, and to respectively modulate the first to N-th transformed lights based on the first to N-th kernel data to output first to N-th kernel product lights, respectively;
first to N-th inverse transform devices configured to respectively perform inverse Fourier transform on the first to N-th kernel product lights, respectively, and to output first to N-th inversely transformed lights, respectively.

5. The optical convolutional computing device of claim 1, wherein each of the first to N-th transform devices includes at least one lens.

6. The optical convolutional computing device of claim 1, wherein the image-based SLM is a transmissive SLM,
wherein the multi-wavelength light is input to the image-based SLM in a first direction, and the image-based SLM outputs the modulated light to the optical demultiplexer in the first direction,
wherein the optical demultiplexer includes first to N-th optical devices disposed in parallel in the first direction, and
wherein the first to N-th optical devices output the first to N-th sub-lights in a second direction perpendicular to the first direction, respectively.

7. The optical convolutional computing device of claim 6, wherein the first optical device among the first to N-th optical devices includes at least one dichroic mirror, and each of the remaining optical devices among the first to N-th optical devices includes at least one beam splitter or at least one polarizing beam splitter.

8. The optical convolutional computing device of claim 6, wherein the N-th optical device among the first to N-th optical devices:
receives the modulated light;
outputs light corresponding to the N-th wavelength among the first to N-th wavelengths from the modulated light as the N-th sub-light in the second direction; and
outputs the remaining light, excluding the light corresponding to the N-th wavelength from the modulated light, in the first direction to the (N−1)-th optical device among the first to N-th optical devices.

9. The optical convolutional computing device of claim 6, wherein each of the first to N-th kernel-based SLMs is a transmissive SLM, and
wherein the first kernel-based SLM among the first to N-th kernel-based SLMs:
receives the first transformed light among the first to N-th transformed lights in the second direction; and
modulates the first transformed light based on the first kernel data among the first to N-th kernel data and outputs the first kernel product light to the first inverse transform device among the first to N-th inverse transform devices in the second direction.

10. The optical convolutional computing device of claim 6, wherein the optical multiplexer includes:
first to N-th optical devices configured to receive the first to N-th inversely transformed lights in the second direction and align the paths of the first to N-th inversely transformed lights into a third direction.

11. The optical convolutional computing device of claim 10, wherein the third direction is the same as the first direction.

12. The optical convolutional computing device of claim 1, wherein the image-based SLM is a reflective SLM,
wherein the optical convolutional computing device further includes an incident device configured to change an optical path of the multi-wavelength light received from the multi-wavelength light generator in a first direction to a second direction that is perpendicular to the first direction, and
wherein the image-based SLM is configured to output the modulated light to the optical demultiplexer in a direction opposite to the second direction.

13. The optical convolutional computing device of claim 12, wherein each of the first to N-th kernel-based SLMs is a reflective SLM, and
wherein the optical convolutional computing device further includes first to N-th incident devices disposed parallel to the optical demultiplexer in the first direction, respectively, and
wherein the first to N-th incident devices are configured to:
respectively receive the first to N-th kernel product lights from the first to N-th kernel-based SLMs in a direction opposite to the first direction; and
respectively change optical paths of the first to N-th kernel product lights to an opposite direction of the second direction to output the first to N-th kernel product lights to the optical multiplexer, respectively.

14. The optical convolutional computing device of claim 1, wherein the multi-wavelength light generator includes:
a first diffraction grating configured to receive the first to N-th input lights in different first to N-th directions and align optical paths of the first to N-th input lights in an (N+1)-th direction to output the multi-wavelength light.

15. The optical convolutional computing device of claim 14, wherein the optical demultiplexer includes a second diffraction grating configured to receive the modulated light and output the first to N-th sub-lights respectively having the first to N-th wavelengths in different (N+2)-th to (2N+1)-th directions, respectively.

16. The optical convolutional computing device of claim 15, wherein the first transform device among the first to N-th transform devices receives the first sub-light in the (N+2)-th direction, and
the optical convolutional computing device further includes:
first to (N−1)-th prisms configured to respectively receive the second to N-th sub-lights, change optical paths of the second to N-th sub-lights among the first to N-th sub-lights, and output the second to N-th sub-lights to the second to N-th inverse transform devices among the first to N-th inverse transform devices, respectively.

17. The optical convolutional computing device of claim 14, further comprising:
a third diffraction grating, and
wherein the third diffraction grating is configured to:
receive the first to N-th inversely transformed lights, respectively; and
align the paths of the first to N-th inversely transformed lights in a single direction so as to be output as the synthesized light.

18. The optical convolutional computing device of claim 1, wherein the multi-wavelength light generator outputs the multi-wavelength light by aligning optical paths of the first to N-th input lights.

19. An optical convolutional computing device, comprising:
a digital demultiplexer configured to modulate the multi-wavelength light based on a spatial domain image data, and output first to N-th sub-lights in first to N-th directions, respectively;
first to N-th transform devices configured to perform Fourier transform on the first to N-th sub-lights and output first to N-th transformed lights, respectively;
first to N-th digital devices configured to receive first to N-th kernel data and modulate the first to N-th transformed lights based on the first to N-th kernel data to output first to N-th kernel product lights, respectively;
first to N-th inverse transform devices configured to perform inverse Fourier transform on the first to N-th kernel product lights and output first to N-th inversely transformed lights, respectively;
an optical multiplexer configured to align paths of the first to N-th inversely transformed lights and output synthesized light; and
an image sensor configured to sense the synthesized light,
wherein N is a natural number greater than or equal to 2.

20. The optical convolutional computing device of claim 19, wherein at least one of the digital demultiplexer or each of the first to N-th digital devices includes a DMD (digital micro-mirror device).
